(19) United States
(12) Patent Application Publication
(10) Pub. No.: US 2016/0158887 A1
(43) Pub. Date: Jun. 9, 2016

(54) DEVICE FOR MACHINING MATERIAL USING A LASER BEAM

(71) Applicant: ROBERT BOSCH GMBH, Stuttgart (DE)

(72) Inventor: Andreas ENGELMAYER, Stuttgart (DE)

(21) Appl. No.: 14/907,144

(22) PCT Filed: Jun. 17, 2014
(86) PCT No.: PCT/EP2014/062679

§ 371 Date: Jan. 22, 2016

(30) Foreign Application Priority Data
Aug. 6, 2013 (DE) 10 2013 215 442.9

(51) Int. Cl. B23K 26/06

(52) U.S. Cl. CPC B23K 26/0643

(57) ABSTRACT

A device for guiding a laser beam for machining a work piece, the laser beam being guided via a mirror system and a focusing optical system to processing points on the work piece that are preselectable by a suitable alignment of the mirrors. The mirror system is disposed farther away than the simple focal length from the optical main plane of the optical system. The device makes it possible to machine work pieces having elevations with the aid of a laser scanning device without the occurrence of self-shading.

### FIELD

The present invention relates to a device for guiding a laser beam in order to machine a work piece, the laser beam being guided to selectable machining points on the work piece via a mirror system and a focusing optical system by suitable alignment of the mirror system.

### BACKGROUND INFORMATION

Laser beams for machining materials, for example, are used for marking purposes, for drilling circuit boards, welding plastic parts, and also for sintering. When machining the material with the aid of the laser beams, a scanner having two rotatable scanner mirrors, which are generally disposed at a right angle with respect to each other, may be used for steering the radiation to selectable positions on a work piece. The guidance is carried out in such a way that a selectable scanning field in two or three dimensions can be achieved on the work piece; the scanning field is two-dimensional in most cases, but can also be expanded to three dimensions. The focusing of the laser beams may be achieved with the aid of a flat-field objective which focuses the laser beams on the object in one plane. Among other things, the location of the focus depends on the angle of incidence of the laser beams into the flat-field objective. Since the deflection of the laser beam on the object is typically nearly proportional to the angle of incidence of the radiation into the objective, the scanner mirrors are often placed in close proximity to the objective in an effort to realize as large a machining field as possible before vignetting of the radiation by the objective occurs. The angle of incidence of the laser radiation is negligible if a planar work piece is involved, but may certainly play an important role when machining a work piece which has a three-dimensional form. In case of a planar work piece, the angle of incidence of the laser radiation on the focal plane thus extends at a right angle to the optical axis of the system; furthermore, it tilts away from the optical axis beyond the optical axis and increases in the direction of the edge of the machining field.

As an alternative, the focusing of the laser beams on the work piece may also be realized by a telecentric objective in which the incident radiation impinges upon the work piece in a generally perpendicular fashion across the entire machining area. However, these telecentric objectives are more expensive and still cause a certain degree of shading, so that they do not achieve the objective of the present invention in a satisfactory manner. Special objectives for machine vision have an optical path which features beams that are inwardly inclined toward the optical axis on the objective side. These objectives are unsuitable for use with laser radiation of a high power density since they do not have the coating of the lenses that is required for such a purpose.

Disadvantageous in the systems currently used for guiding the beams is that in the case of three-dimensional objects, a portion of the laser radiation, e.g., in the region to the side of the optical axis but also on the optical axis, may possibly be shaded by the object. This may result in a poorer machining quality or in damage to the work piece if laser beams impinge upon an elevated part of the work piece. In the prior art, additional mirrors fixed in place along the sides therefore are used for guiding the laser radiation onto the object. This requires a precise adjustment and may lead to problems caused by soiling of the cartridge mirrors.

If such three-dimensional work pieces are machined without the scan functionality, the machining speed drops and machining is impossible in unfavorable cases. As an alternative, a wobble scan system or a trepanning optical system may be used for guiding the radiation, in which a lateral offset from laser radiation impinging upon the work piece in a perpendicular manner can be achieved via three wedge plates. These optomechanical systems are complex, however, and consequently quite expensive.

Therefore,it is the object of the present invention to provide a device which makes it possible to machine even three-dimensionally formed objects at a higher quality with the aid of laser radiation, in particular without any adverse effect by self-shading.

### SUMMARY

In accordance with example embodiments of the present invention, an object of the present invention may be achieved by placing the mirror system farther away from the optical main planes of the optical system than the simple focal length.

Frequently used as the focusing optical system is what is generally known as an F-theta objective, which focuses the incoming radiation on the work piece in a focal point at a distance from the optical axis, virtually in proportion to its impingement angle. The mirrors are positioned as close as possible to the focusing optical system in an effort to realize large entry angles, and consequently, a large machining area. The laser radiation impinges outside the optical axis at an angle that faces away from the optical axis and can therefore be shaded by elevated regions on the work piece. In the present invention, on the other hand, the laser radiation impinges beyond the optical axis at an angle that faces the optical axis. This is achieved by placing the scanner mirrors farther away from the focusing optical system than in the related art. Currently, the mirrors are situated within the simple focal length of the focusing optical system, so that the desired large machining zone is able to be achieved. This causes the optical path to tilt away from the optical axis, the angle increasing as the distance from the optical axis grows larger. If the mirrors were positioned in the focus of the optical system, the emergent radiation would be oriented essentially in parallel with the optical axis. Because of the placement outside the focusing distance according to the invention, the emergent radiation is inclined toward the optical axis, as desired, and positions on the work piece can be machined without shading caused by an elevated area in the center of the work piece. Even simple objectives are able to satisfy the requirements, e.g., when welding plastic components, for which a focus diameter of one millimeter or greater is frequently sufficient. By way of example, the system allows two pipes inserted into each other to be welded together. In conventional systems this is possible only with the help of circumventing measures.

If the mirror system includes two mobile mirrors having individual pivot axes, the mirrors are able to be moved in a particularly rapid manner with the aid of a galvanometric drive, and the laser beam can thereby be positioned on and guided to the machining points on the work piece. A brief machining duration, high machining or traversing speeds (for example for quasi-simultaneous welding) and a high throughput of work pieces are achievable as a result.

In one preferred development, the focusing optical system is developed as a flat-field objective. If a flat-field objective is used, which may be an F-theta objective, the laser radiation on a work piece may also achieve a smaller focus diameter on a planar machining plane, or better a better imaging quality. If a simpler focusing optical system is employed, it focuses the laser light onto a spherical shell by way of example, so that a larger focal point is created in the region beyond the optical axis, or the work piece or optical system must be adjusted accordingly.

In one further preferred specific embodiment, the mirror system is realized in the form of two deflection mirrors which are essentially orthogonal with respect to each other, or in the form of a gimbal-mounted single mirror. This makes it possible to use a conventional scanning head featuring a high machining speed, yet still avoid self-shading by an elevation on the work piece.

### BRIEF DESCRIPTION OF THE DRAWINGS

The present invention is discussed in greater detail below based on an exemplary embodiment shown in the figures.

FIG. 1 shows a beam characteristic according to the related art.

FIG. 2 shows a beam characteristic in the system according to the invention.

FIG. 3 shows a beam characteristic when machining two pipes.

### DETAILED DESCRIPTION OF EXAMPLE EMBODIMENTS

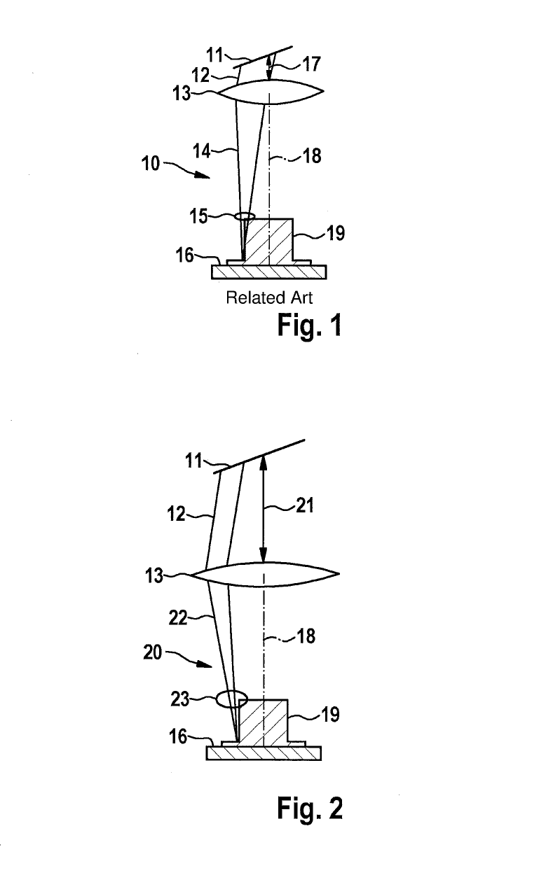

FIG. 1 shows a first scanner system 10 according to the related art, which is used for machining a work piece upper part 19 and a work piece lower part 16 with the aid of laser radiation. In the example, work piece upper part 19 has a base plate that faces work piece lower part 16 and is welded to work piece lower part 16. With the aid of at least one deflection mirror 11, light from a laser source is supplied in scanner system 10 as an incident beam 12 to a focusing lens 13, which focuses the laser light as first emergent beam 14 on the base plate of work piece upper part 19. Two deflection mirrors, which are roughly (not quite) orthogonal with respect to each other, are generally used for the deflection, one of which, deflection mirror 11, being shown here. As an alternative, for example, it is also possible to use a single gimbal-mounted deflection mirror 11 or a piezo system may be used for the rotation about the two non-parallel axes of rotation. Deflection mirror 11 is disposed at a first mirror distance 17 from focusing lens 13, so that it is situated within the simple focal length of focusing lens 13. First emergent beam 14 is tilted away from an optical axis 18, the angle of inclination increasing with the distance of the impingement point on work piece upper part 19 from the optical axis. In the exemplary embodiment illustrated here, work piece upper part 19 has a work piece elevation in the central region. Because of the placement, first emergent beam 14 impinges upon the work piece elevation in a self-shading region 15. This may cause damage to work piece upper part 19 in shelf-shading region 15 and/or the beam quality or beam intensity in the machining point on work piece upper part 19 may be insufficient.

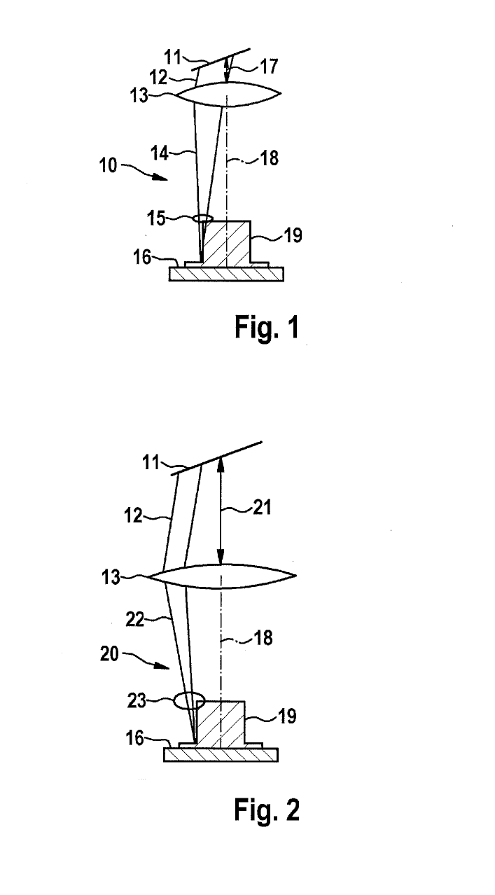

FIG. 2 shows a second scanning system 20 featuring the improved system according to the present invention. Components that match those in FIG. 1 have been provided with the same reference numerals. Deflection mirror 11 is situated at a mirror distance 21 that is greater than first mirror distance 17. Incident beam 12 impinges upon focusing lens 13 at a greater distance from optical axis 18 than in first scanner system 10. If the focal length of focusing lens 13 is identical to the system from FIG. 1 and if focusing lens 13 behaves like an F-theta objective in the first approximation, the laser beam as second emergent beam 22, tilted inwardly toward optical axis 18, impinges upon the same location on the work piece as in FIG. 1. Second emergent beam 22 passes the work piece elevation on work piece upper part 19 within a free beam region 23 and is focused on work piece upper part 19 at the beam quality required for the machining. Depending on an available space between focusing lens 13 and work piece upper part 19, the smallest possible focal length of focusing leans 13 may be used in order to achieve an angle of incidence that is tilted as much as possible toward the optical axis. Within the framework of an optimization, a reduction of the beam diameter may be useful, as well. A conventional flat-field objective, for instance a so-called F-theta objective, may be used as focusing leans 13.

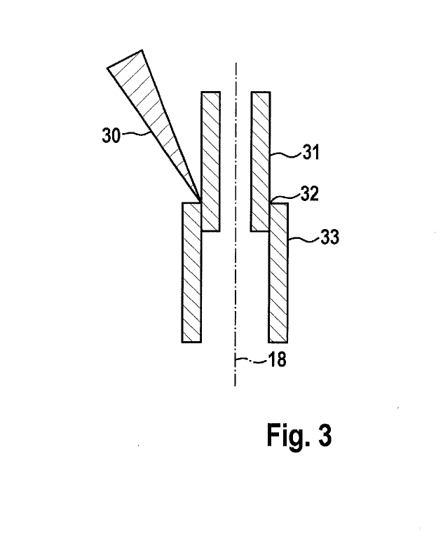

FIG. 3 shows an example for the use of the inventive device for machining material with the aid of a laser beam. A first pipe piece 31 is inserted into a second pipe piece 33 and both pipe pieces 31, 33 are to be joined to one another along a circumferential welding seam 32. To do so, laser radiation 30 impinges upon welding seam 32 at an angle that is inclined toward optical axis 18. The inclination of laser radiation 30 toward optical axis 18 makes it possible to avoid shading of laser radiation 30 by first pipe piece 31.

1-4. (canceled)

5. A device for guiding a laser beam for machining a work piece, comprising:
a mirror system and a focusing optical system to guide the laser beam to machining points on the work piece that are preselectable an alignment of the mirror system;
wherein the mirror system is disposed farther away from an optical main plane of the optical system than a simple focal length.

6. The device as recited in claim 5, wherein the mirror system includes two mobile mirrors each having an axis of rotation.

7. The device as recited in claim 5, wherein the focusing optical system is a flat-field objective.

8. The device as recited in claim 5, wherein the mirror system includes one of: i) two deflection mirrors that are approximately orthogonal with respect to each other, or ii) a gimbal-mounted individual mirror.
